(19) United States
(12) Patent Application Publication
(10) Pub. No.: US 2015/0345703 A1
(43) Pub. Date: Dec. 3, 2015

(54) STATION FOR FILLING TANKS WTIH COMPRESSED GAS

(71) Applicant: L'Air Liquide, Société Anonyme pour l'Etude et l'Exploitation des Procédés Georges Claude, Paris (FR)

(72) Inventor: Laurent ALLIDIERES, Saint Martin d'Uriage (FR)

(21) Appl. No.: 14/722,977

(22) Filed: May 27, 2015

(30) Foreign Application Priority Data
May 28, 2014 (FR) 1454816

(51) Int. Cl. F17C 5/00; F17C 13/02; F17C 5/06

(52) U.S. Cl. CPC F17C 5/007; F17C 5/06; F17C 13/02; F17C 2221/012

(57) ABSTRACT

Station for filling compressed-gas tanks, comprising a gas distribution terminal comprising at least one pipe one end of which is fitted with a connector to be fluidically connected to a tank, the distribution terminal being fluidically connected to a source of gas via a compressed-gas distribution circuit, the station comprising at least one heat exchanger to cool the gas, the heat exchanger being situated on the distribution circuit, the distribution terminal and the heat exchanger being arranged on a common support, the heat exchanger being arranged underneath the distribution terminal, and the support being able to move between a lowered first position in which the base of the terminal rests at ground level while the heat exchanger is situated in a cavity below ground level, and a raised second position in which the exchanger is raised out of the cavity to ground level or above ground level.

### CROSS REFERENCE TO RELATED APPLICATIONS

This application claims the benefit of priority under 35 U.S.C. §119 (a) and (b) to French Patent Application No. 1454816 filed May 28, 2014, the entire contents of which are incorporated herein by reference.

### BACKGROUND

The present invention relates to a fuel-gas filling station.

The invention relates more particularly to a station for filling tanks with compressed fuel gas, comprising a gas distribution terminal comprising at least one pipe one end of which is fitted with a connector intended to be fluidically connected to a tank that is to be filled, the distribution terminal being fluidically connected to a source of gas via a compressed-gas distribution circuit, the station comprising at least one heat exchanger in a heat exchange relationship with the gas supplied to the distribution terminal so as to cool the said gas, the heat exchanger being situated on the distribution circuit.

The invention relates notably to filling stations for filling compressed-hydrogen tanks of fuel-cell vehicles. These filling stations are intended to fill the tanks in a few minutes at a high pressure, for example 700 bar.

In order to allow rapid filling, the hydrogen in certain instances needs to be cooled before it is injected into the vehicle tank. This is because, in order to allow the rapid filling of the tanks, the hydrogen needs for example to be cooled to a temperature which may be as low as −40° C. To achieve that, the filling station generally comprises a heat exchanger intended to cool the gas with which the vehicle is filled. The heat exchanger needs to be as close as possible to the hydrogen distribution terminal in order to guarantee a distribution of cold gas as early on as possible during the filling (which means to say in order to minimize the time taken to cool the pipework between the exchanger and the distribution terminal).

Hydrogen-gas filling stations are increasingly being incorporated into existing filling stations that deliver all kinds of fuel (notably petrol).

The fuel distribution terminals are placed on islands, namely sites in the filling station that have a determined footprint. The width of these islands is usually determined by the width of the conventional fuel distribution terminals. The length of these islands varies according to the configuration of the site, of the order of 3 to 4 m per terminal. The solutions proposed need to be compact.

One first known solution is to place a heat exchanger in the distribution terminal. However, in this case, it is difficult to incorporate into an existing “standard” island of the station because the exchanger has a diameter close to the width of the island and the length of the island does not allow the incorporation of a distribution terminal comprising an exchanger.

In another solution, the heat exchanger is positioned not in the distribution terminal but as close as possible to the distribution terminal. This entails placing the heat exchanger in the island, in an underground cavity. This solution does, however, entail providing space available for the exchanger in the filling station and does not make installing or maintaining it easy (the gas-distribution terminal and the cooling exchanger are then two separate entities that have to be incorporated into the site). In addition, the pipework between the distribution terminal and the exchanger needs to be insulated or cooled, making mounting the system on site more complicated.

Another solution is for the gas cooling system (the heat exchanger) to be sited remotely with respect to the filling terminal. In that case, the pipes transferring the cooled gas need to be thermally insulated in order to maintain the cold between the remotely sited exchanger and the distribution terminal or, in another known solution, the pipes need to be actively cooled by the refrigerant. This increases the complexity and cost of the station as a result of the need to provide an insulated and cooled high-pressure circuit for the gas.

### SUMMARY

It is an object of the present invention to alleviate all or some of the abovementioned disadvantages of the prior art.

To this end, the station according to the invention, in other respects conforming to the generic definition given thereof in the above preamble, is essentially characterized in that the distribution terminal and the heat exchanger are arranged on a common support, the heat exchanger being arranged underneath the distribution terminal, and the support being able to move between a lowered first position in which the base of the terminal rests at ground level while the heat exchanger is situated in a cavity below ground level, and a raised second position in which the exchanger is raised out of the cavity to ground level or above ground level.

This allows a heat exchanger to be incorporated into the distribution terminal while at the same time having a limited footprint and optimum accessibility.

Moreover, some embodiments of the invention may involve one or more of the following features:

the support is connected to a lifting mechanism comprising at least one of the following: a lift table, a lift, a pantograph mechanism,

the support is connected to a mechanical and/or hydraulic and/or electric lifting mechanism,

the heat exchanger is supplied with frigories from a cold source of refrigerant via a refrigerant-fluid circuit, the refrigerant-fluid circuit comprising a region of quick connection/disconnection with respect to the heat exchanger so as to allow the heat exchanger and refrigerant-fluid circuit to be disconnected/connected,

the station comprises a locking member for locking the support in the lowered position, the locking member being switchable between a first state in which the locking member immobilizes the support in its lowered first position, i.e. prevents it from moving towards the raised second position and a second state in which the locking member allows the support to move towards the raised second position,

the locking member is connected to or collaborates with the region of quick connection/disconnection and is configured to switch into its first state and immobilize the support in its lowered first position as long as the heat exchanger is connected to the refrigerant-fluid circuit,

the distribution circuit comprises a region of rapid connection/disconnection with respect to the heat exchanger and/or the terminal so as to allow the distribution circuit, on the one hand, to be disconnected/connected with respect to, on the other hand, the heat exchanger or the terminal,

the locking member is connected to or collaborates with the region of rapid connection/disconnection and is configured to switch into its first state immobilizing the support in its lowered first position as long as the heat exchanger or the terminal is connected to the distribution circuit,

the locking member comprises a mechanical and/or electrical member connected to the mobile support and physically or electrically connected to the region of rapid connection,

the lifting mechanism comprises an actuating member controlled electrically via electronic data-processing logic, the electronic logic incorporating the locking member.

The invention may also relate to any alternative device or method comprising any combination of the features listed above or below.

### BRIEF DESCRIPTION OF THE DRAWINGS

Other specific features and advantages will become apparent from reading the description hereinafter given with reference to the figures in which:

FIG. 1 depicts a schematic and partial view in vertical section illustrating one embodiment of a filling station according to the invention in a lowered first configuration,

FIG. 2 depicts the station of FIG. 1 but in a raised second configuration,

FIG. 3 depicts a perspective and schematic view illustrating one possible embodiment of a mobile support system.

### DESCRIPTION OF PREFERRED EMBODIMENTS

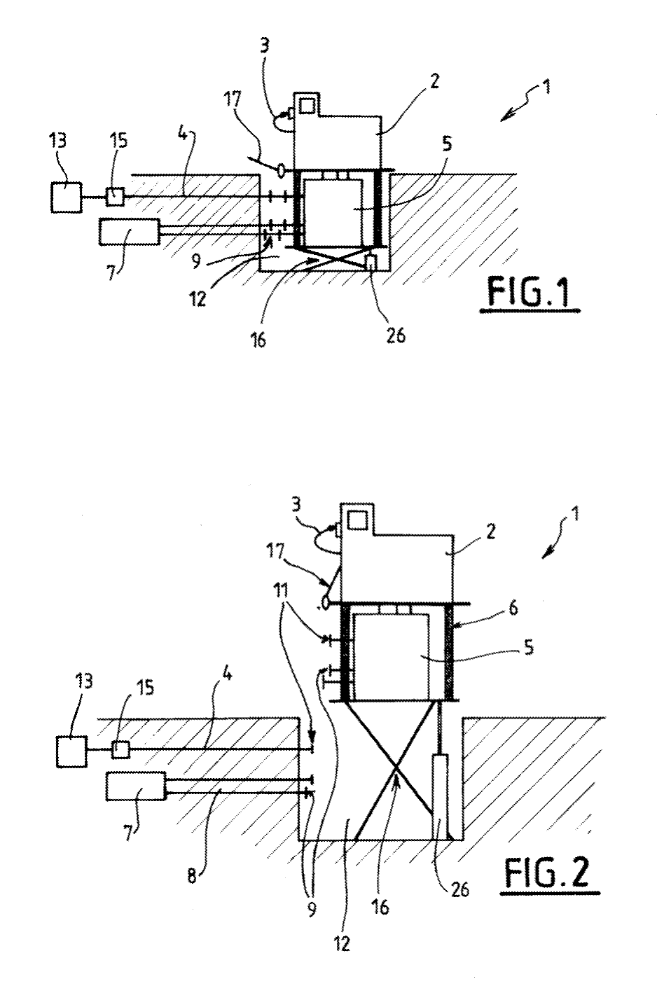

FIGS. 1 and 2 depict one example of a filling station for filling tanks with compressed fuel gas (for example hydrogen).

The station 1 in the conventional way comprises a gas distribution terminal 2 comprising at least one hose 3 one end of which is equipped with a connector intended to be fluidically connected to a tank that is to be filled (for example a motor vehicle tank).

The distribution terminal 2 is fluidically connected to a source 13 of compressed gas via a pressurized gas-distribution circuit 4. For example, at least part of the distribution circuit 4 is underground and/or built into a gully.

The station 1 comprises a heat exchanger 5 provided conventionally for cooling the compressed gas with which the tanks are being filled. The heat exchanger 5 is in a heat exchange relationship with the gas supplied to the distribution terminal 2.

For example, the terminal 2 is supplied with compressed gas from one or more tanks 13 and possibly a compressor 15. Of course, any other system for supplying compressed gas may be provided (a system of several tanks in parallel in order to perform filling by successive “cascaded” equalizing of pressure, a system for producing compressed gas from a tank of liquefied gas and a vaporizer, etc.). The source 13 of gas supplies the distribution terminal 2 via the distribution circuit 4 and the exchanger 5.

The heat exchanger 5 is situated on the distribution circuit 4 for example just upstream of the distribution terminal 2 (in the direction in which the gas flows).

The heat exchanger 5 is, for example, an exchanger providing an exchange of heat between the gas that is to be cooled and a cooling fluid. For this purpose, the heat exchanger 5 may be supplied with frigories from a cold source 7 via a refrigerant-fluid circuit 8. For example, the cooling circuit and notably the exchanger may comprise all or some of the features described in document FR2928716A1. The cooling fluid may comprise a liquid such as nitrogen, glycol-water, salt water or any other appropriate fluid. The exchanger 5 may comprise aluminium or any other material and may comprise a mass forming a block of material of high thermal inertia to form a frigory accumulator.

According to one advantageous feature, the distribution terminal 2 and the heat exchanger 5 are arranged on the common support 6, the heat exchanger 5 being arranged underneath the distribution terminal 2 and the support 6 is able to move between a lowered first position in which the base of the terminal 2 rests at ground level while the heat exchanger 5 is situated in a cavity 12 below ground level, and a raised second position in which the exchanger 5 is raised up out of the cavity 12 to ground level or above ground level.

For example, the support 6 may comprise two superposed plates on which the filling terminal 2 and the exchanger 5 are respectively placed.

The support 6 is connected to a lifting mechanism 16, 26 that allows the assembly to be raised and lowered again.

The mechanism comprises for example at least one of the following: a lift table, a lift, a pantograph mechanism, a cable(s)-and-pulley (pullies) mechanism.

What this means to say is that the support 6 is connected to a mechanical and/or hydraulic and/or electrical lifting mechanism (lift) 16, 26.

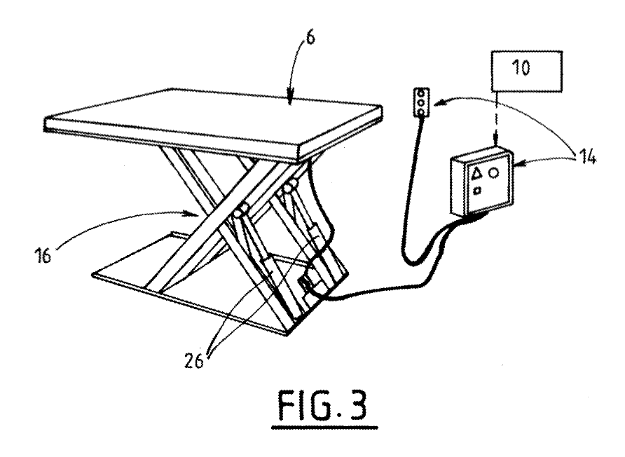

FIG. 3 illustrates one example of a lifting plate mounted on two pairs of pantographs 16 which are actuated by a system of hydraulic or pneumatic rams 26 controlled by an electronic control unit 14. The lifting plate is, for example, arranged on/fixed to the bottom of the underground cavity 12.

Of course any other appropriate lifting system could be used, for example a cable(s)-and-pulley (pullies) mechanism.

In operational mode (when the station 1 is in the configuration for filling the tanks), the support 6 is in the lowered position (cf. FIG. 1). By contrast, to facilitate maintenance, the support 6 can be raised (FIG. 2).

For preference, the station 1 comprises a locking member 14 for locking the support 6 in the lowered position. The locking member 14 can be switched between a first state in which the locking member 14 immobilizes the support 6 in its lowered first position, namely prevents it from moving towards the raised second position, and a second state in which the locking member 14 allows the support 6 to be moved towards the raised second position.

The locking member 14 may comprise a mechanical catch (stop) and/or an electric lock where appropriate.

For preference also, the refrigerant-fluid circuit 8 comprises a region 9 of rapid connection/disconnection with respect to the heat exchanger 5 in order to allow the heat exchanger 5 and the refrigerant-fluid circuit 8 to be disconnected/connected. This connection/disconnection region 9 comprises for example a set of rapid connector(s) for fluidically connecting, or not connecting, the refrigerant-fluid circuit 8 to the heat exchanger 5.

The connection lines of the circuits 4, 8 may be flexible or semi rigid, connected to connectors that can be detached in order to compensate for misalignments of the piping.

Likewise, according to the same principle as described hereinabove, the distribution circuit 4 may also comprise a region 11 of rapid connection/disconnection with respect to the heat exchanger 5 (and/or the terminal 2) to allow the heat exchanger 5 (or the terminal 2) to be disconnected/connected with respect to the compressed-gas distribution circuit 8.

For preference, the locking member 14 is connected to or collaborates with the region 9 of rapid connection/disconnection and is configured for switching into its first state and immobilize the support 6 in its lowered first position as long as the exchanger 5 and/or the distribution terminal 2 is connected to the refrigerant-fluid circuit 8 or to the distribution circuit 4.

What that means to say is that the locking system that locks the mechanism prevents any movement of the support 6 if one of the sets of piping has not been disconnected. This mechanical system may be a physical rotatary shutter mechanically or electrically coupled to the raising system which allows the support 6 to be raised only when all the connectors 9, 11 are disconnected.

In the example of FIG. 3, the vertical position of the support 6 is determined by a system of rams 26 which is controlled electrically via a system 14 comprising, for example, an electrical cabinet and a manual push-button terminal. For example, the control for raising the support 6 is deactivated by its electronic control logic for example as long as a sensor 10 indicates that the fluidic connectors 9, 11 have not been disconnected. The sensor 10 may comprise at least one of the following: an electrical sensor, a pressure sensor, a breaker switch, an optical sensor, etc.

In this way, the heat exchanger 5 (and the terminal 2) have to be detached from the fluidic circuits that supply them before the support 6 is raised. This makes it possible to avoid accidents and the breaking of cables for example.

The station 1 may comprise a mobile hood or flap 17 providing access to the regions 9, 11 of connection/disconnection in the cavity 12 when the support 6 is in the lowered position. The flap 17 is, for example, mounted with the ability to move (articulate) on the support 6.

For example, the locking member 14 and/or the system for raising the support 6 is inaccessible or deactivated as long as the circuits 4, 8 remain fluidically connected to the terminal 2 and/or to the exchanger 5.

The station 1 offers numerous advantages, notably:

great compactness,

low cost of installation (as the heat exchanger 5 can be assembled with the distribution terminal 2 in advance at the factory),

a siting of the heat exchanger 5 as close as possible to the filling terminal 2, allowing the gas to be cooled effectively,

ease of access to the heat exchanger 5 for maintenance thereof (notably as compared with a fixed buried solution).

It will be understood that many additional changes in the details, materials, steps and arrangement of parts, which have been herein described in order to explain the nature of the invention, may be made by those skilled in the art within the principle and scope of the invention as expressed in the appended claims. Thus, the present invention is not intended to be limited to the specific embodiments in the examples given above.

1. A station for filling tanks with compressed fuel gas, the station comprising a gas distribution terminal comprising at least one pipe one end of which is fitted with a connector configured to be fluidically connected to a tank that is to be filled, the distribution terminal being fluidically connected to a source of gas via a compressed-gas distribution circuit, the station comprising at least one heat exchanger in a heat exchange relationship with the gas supplied to the distribution terminal so as to cool the said gas, the heat exchanger being situated on the distribution circuit, wherein the distribution terminal and the heat exchanger are arranged on a common support, the heat exchanger being arranged underneath the distribution terminal, and in that the support is able to move between a lowered first position in which the base of the terminal rests at ground level while the heat exchanger is situated in a cavity below ground level, and a raised second position in which the exchanger is raised out of the cavity to ground level or above ground level.

2. The station of claim 1, wherein the support is connected to a lifting mechanism comprising at least one of the following: a lift table, a lift, a pantograph mechanism.

3. The station of claim 1, wherein the support is connected to a mechanical and/or hydraulic and/or electric lifting mechanism.

4. The station of claim 1, wherein the heat exchanger is supplied with frigories from a cold source of refrigerant via a refrigerant-fluid circuit, and in that the refrigerant-fluid circuit comprises a region of quick connection/disconnection with respect to the heat exchanger so as to allow the heat exchanger and refrigerant-fluid circuit to be disconnected/connected.

5. The station of claim 1, wherein the station comprises a locking member for locking the support in the lowered position, the locking member being switchable between a first state in which the locking member immobilizes the support in its lowered first position.

6. The station of claim 4, wherein the locking member is connected to or collaborates with the region of quick connection/disconnection and is configured to switch into its first state and immobilize the support in its lowered first position as long as the heat exchanger is connected to the refrigerant-fluid circuit.

7. The station of claim 1, wherein the distribution circuit comprises a region of rapid connection/disconnection with respect to the heat exchanger and/or the terminal so as to allow the distribution circuit to be disconnected/connected with respect to the heat exchanger or the terminal.

8. The station of claim 5, wherein the locking member is connected to or collaborates with the region of rapid connection/disconnection and is configured to switch into its first state immobilizing the support in its lowered first position as long as the heat exchanger or the terminal is connected to the distribution circuit.

9. The station of claim 6, wherein the locking member comprises a mechanical and/or electrical member connected to the mobile support and physically or electrically connected to the region of rapid connection.

10. The station of claim 9, wherein the lifting mechanism comprises an actuating member controlled electrically via electronic data-processing logic, and in that the electronic logic incorporates the locking member.
